(19) United States
(12) Patent Application Publication
(10) Pub. No.: US 2016/0035131 A1
(43) Pub. Date: Feb. 4, 2016

(54) 3D-CG PROCESSING DEVICE AND 3D-CG PROCESSING METHOD

(71) Applicant: FUJITSU LIMITED, Kawasaki-shi (JP)

(72) Inventors: Takao Hirahara, Kawasaki (JP); Masahiro Watanabe, Kawasaki (JP)

(21) Appl. No.: 14/741,759

(22) Filed: Jun. 17, 2015

(30) Foreign Application Priority Data
Jul. 31, 2014 (JP) 2014-156677

(51) Int. Cl. G06T 17/20; G06T 17/30; G06T 17/10; G06T 15/04; G06T 15/08

(52) U.S. Cl. CPC G06T 17/20; G06T 15/04; G06T 15/08; G06T 17/10; G06T 17/30

(57) ABSTRACT

An image processing device includes a processor; and a memory which stores a plurality of instructions, which when executed by the processor, cause the processor to execute: extracting, with a data storage unit configured to store data on a set of three-dimensional polygons disposed in a three-dimensional virtual space, from the three-dimensional polygons stored in the data storage unit, the extracting a three-dimensional polygon disposed on an outer side of the set of three-dimensional polygons; and drawing the extracted three-dimensional polygon.

### CROSS-REFERENCE TO RELATED APPLICATION

This application is based upon and claims the benefit of priority of the prior Japanese Patent Application No. 2014-156677, filed on Jul. 31, 2014, the entire contents of which are incorporated herein by reference.

### FIELD

The embodiments discussed herein are related to an 3D-CG processing device, an 3D-CG processing method, and an 3D-CG processing program, for example.

### BACKGROUND

In recent years, with an increasing performance of computers that execute visualization processing, it has become possible to display a visualization object including a large number of three-dimensional polygons. However, in consideration of a long time taken for the processing, techniques for reducing a processing load are being developed. For example, there is provided a method of displaying only an important part of three-dimensional polygons having data volume of as much as gigabytes to terabytes, or a method of simplifying a complicated shape.

However, with a technique of displaying only an important part, processing load is not reduced when the whole body is displayed. Also, with a technique of simplification, polygons are basically integrated and reorganized. Accordingly, it might result in significant deterioration in display precision compared with the original information. Then, simplification processing, and rendering processing are carried out independently, and thus a lot of the processing procedures are involved. As a result, sometimes the processing time becomes long.

Also, in general, a three-dimensional model is often defined using three-dimensional polygons only for the outer shape of the three-dimensional model, and its inner part is often not defined by three-dimensional polygons. However, in the case of performing simulation on a human organ, for example, a heart, or the like, not only three-dimensional polygons for representing an outer shape of the organ, but also three-dimensional polygons for representing an inner structure of the organ are defined. Accordingly, if an attempt is made to simply draw a set of three-dimensional polygons that represent an organ, or the like, processing, such as hidden surface removal, and the like are carried out on a vast number of three-dimensional polygons. For documents on the above-described techniques, for example, Japanese Laid-open Patent Publication No. 2004-46599, and International Publication Pamphlet No. WO 2007/125912 are given.

### SUMMARY

According to an aspect of the invention, an image processing device includes a processor; and a memory which stores a plurality of instructions, which when executed by the processor, cause the processor to execute: extracting, with a data storage unit configured to store data on a set of three-dimensional polygons disposed in a three-dimensional virtual space, from the three-dimensional polygons stored in the data storage unit, the extracting a three-dimensional polygon disposed on an outer side of the set of three-dimensional polygons; and drawing the extracted three-dimensional polygon.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

These and/or other aspects and advantages will become apparent and more readily appreciated from the following description of the embodiments, taken in conjunction with the accompanying drawing of which:

FIG. 1 is a diagram illustrating an example of an object to be a target of an embodiment;

FIG. 2 is a diagram illustrating an example of an object to be a target of an embodiment;

FIG. 3 is a diagram illustrating an example of a configuration of an image processing device according to an embodiment;

FIG. 4 is a diagram illustrating a flowchart of main processing according to an embodiment;

FIG. 5 is a diagram illustrating a processing flowchart of polygon extraction processing;

FIG. 6 is an explanatory diagram of an initial cutting plane;

FIG. 7 is a diagram schematically illustrating processing in which a line is set on a plane, and then rotated;

FIG. 8 is a diagram illustrating an example of setting an initial line;

FIG. 9 is an explanatory diagram of extraction of neighboring polygons;

FIG. 10 is a diagram schematically illustrating processing in which a line is rotated on a plane;

FIG. 11 is an explanatory diagram of changing cutting planes;

FIG. 12 is an explanatory diagram of changing cutting planes;

FIG. 13 is a diagram illustrating an example of extraction processing in the case of applying a scan line method;

FIG. 14 is a diagram schematically illustrating processing according to the present embodiment;

FIG. 15 is an explanatory diagram of intersection determination processing; and

FIG. 16 is a functional block diagram of a computer.

### DESCRIPTION OF EMBODIMENTS

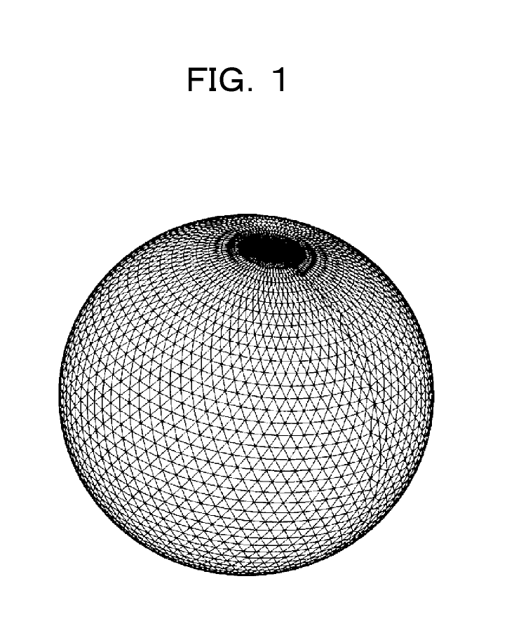

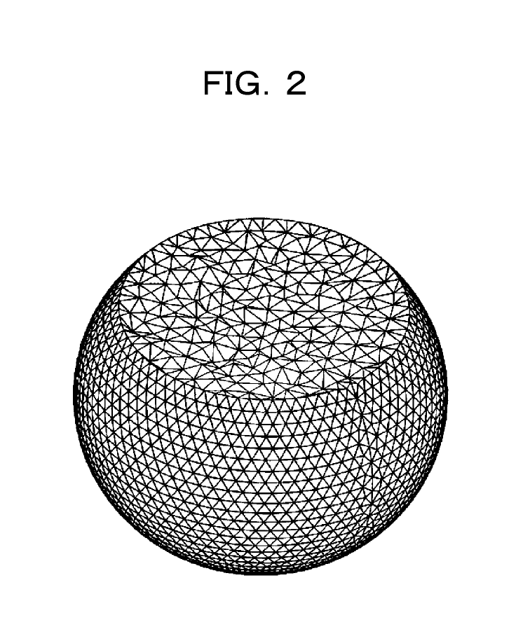

First, a description will be given of characteristics of a set of three-dimensional polygons to be handled by embodiments of the present disclosure. In the present embodiment, as illustrated in FIG. 1, it is assumed that an object having no large-sized concavities, and having a convex outer shape on the whole is drawn. Such an object includes not only a three-dimensional polygon group representing an outer shape, but also a three-dimensional polygon group representing an inner structure, and the like. That is to say, it is assumed that a large number of three-dimensional polygons are disposed at a density equal to or higher than a predetermined density in a certain space in a three-dimensional virtual space. That is to say, if the spherical object illustrated in FIG. 1 is cut by a certain plane, as illustrated in FIG. 2, it is assumed that a large number of three-dimensional polygons are also disposed inside the spherical object.

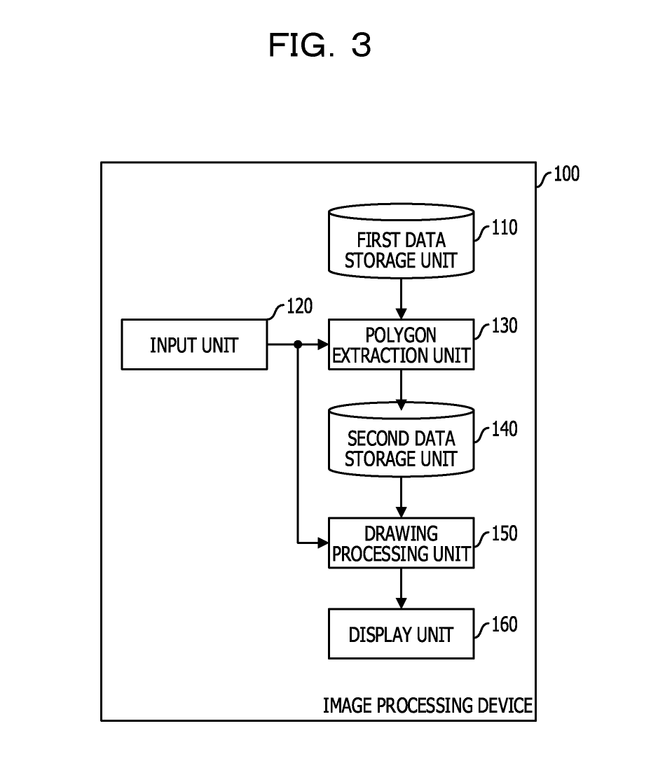

An example of a configuration of an image processing device for drawing such an object at a high speed is illustrated in FIG. 3. An image processing device 100 according to the present embodiment includes a first data storage unit 110, an input unit 120, a polygon extraction unit 130, a second data storage unit 140, a drawing processing unit 150, and a display unit 160.

The first data storage unit 110 stores data of the three-dimensional polygons included in an object to be visualized, for example. The input unit 120 receives, for example input for setting a visual point from a user, and outputs it to the polygon extraction unit 130, and the drawing processing unit 150.

The polygon extraction unit 130 extracts three-dimensional polygons for representing an outer shape of an object to be visualized from a set of three-dimensional polygons stored in the first data storage unit 110 based on the input from the input unit 120, for example, and stores them in the second data storage unit 140.

The drawing processing unit 150 performs drawing processing on a three-dimensional polygon group stored in the second data storage unit 140 based on the input from the input unit 120 to display the object on the display unit 160.

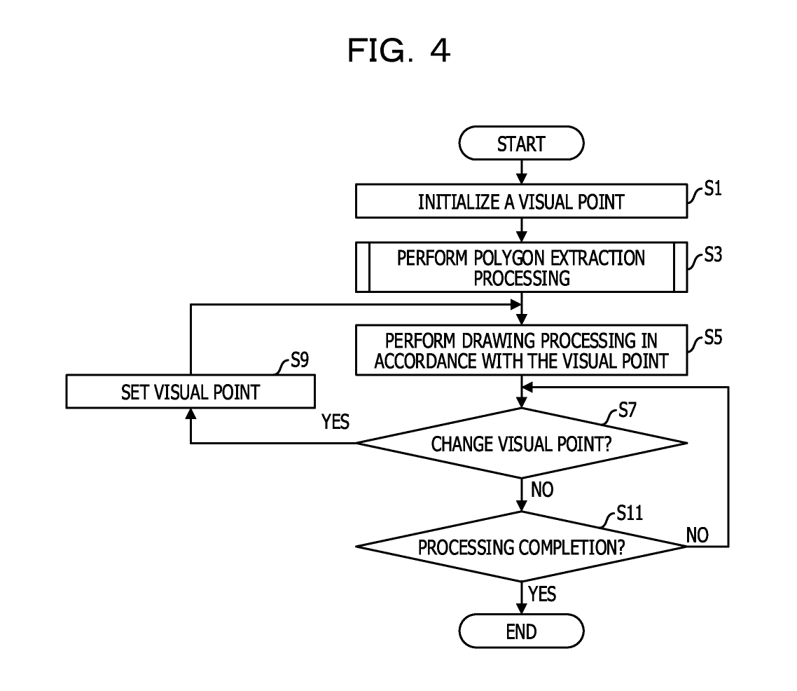

Next, a description will be given of the processing contents of the image processing device 100 using FIG. 4 to FIG. 14.

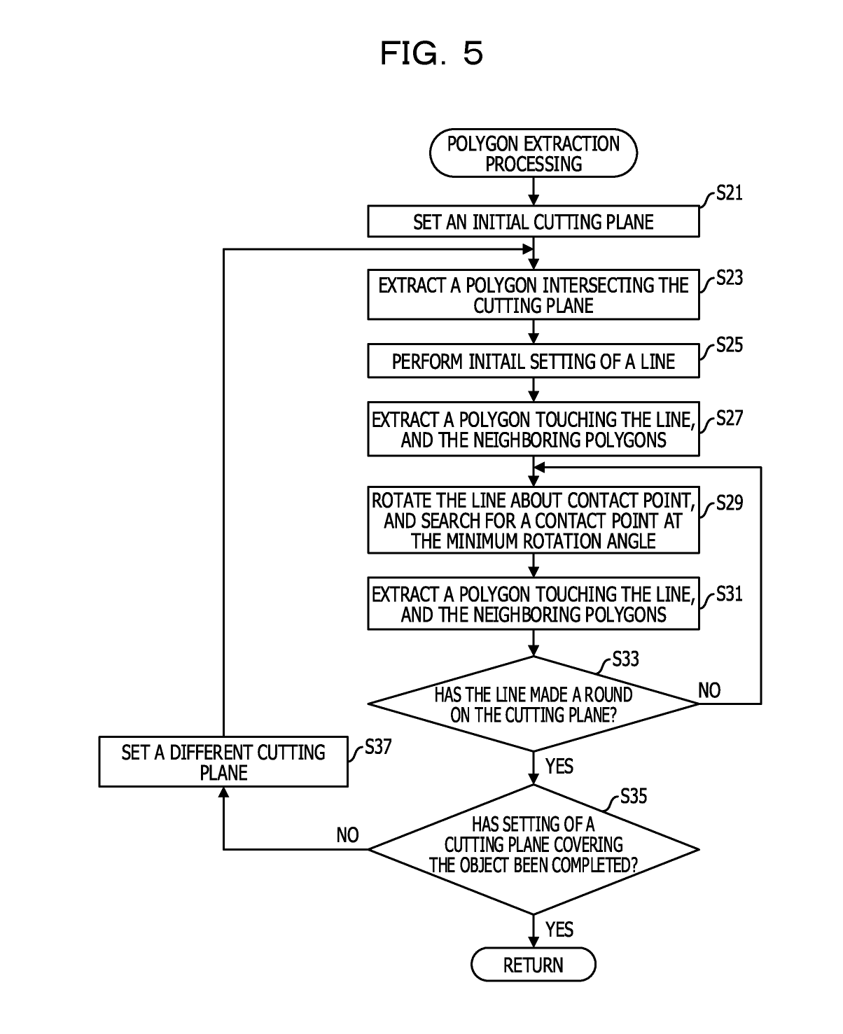

First, the polygon extraction unit 130 initializes a visual point (FIG. 4: step S1). The visual point is set to a predetermined position. In this regard, a user may carry out initialization through the input unit 120. Then, the polygon extraction unit 130 executes polygon extraction processing as pre-processing (step S3). A description will be given of polygon extraction processing using FIG. 5 to FIG. 12.

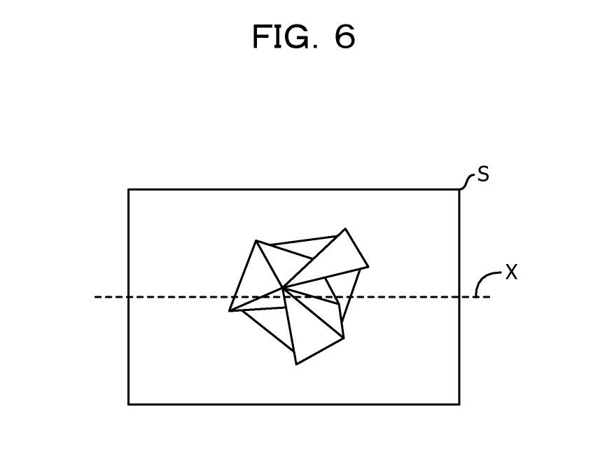

First, the polygon extraction unit 130 sets an initial cutting plane (FIG. 5: step S21). FIG. 6 is a diagram schematically illustrating an object viewed from a projection plane S. In this manner, for example a plane X that passes the visual point and cuts the object is set.

Then, the polygon extraction unit 130 extract a three-dimensional polygon group that intersects the cutting plane (step S23). After that, the polygon extraction unit 130 initializes the line on the cutting plane (step S25). For example, the line passing the visual point is rotated about a visual point on the cutting plane, and a point at which the line contacts the three-dimensional polygon group for the first time is identified.

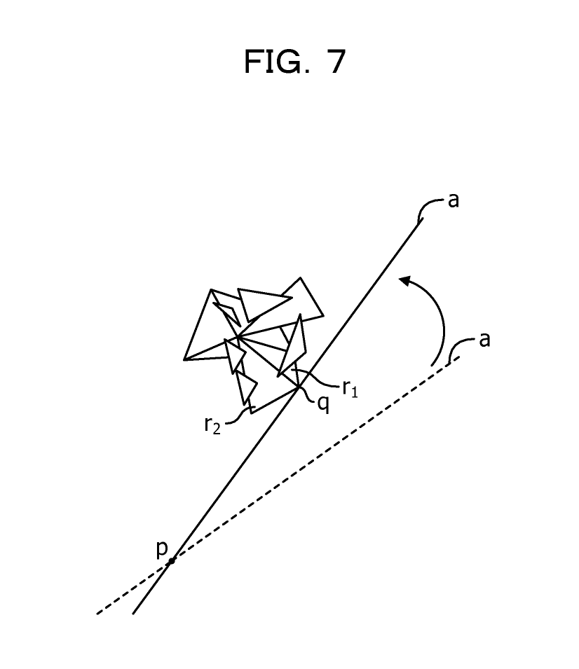

For example, in FIG. 7, it is assumed that this page is used as a cutting plane, and a line “a” passing through the visual point “p” is rotated about a visual point “p” to identify a point “q” that contacts a three-dimensional polygon group for the first time.

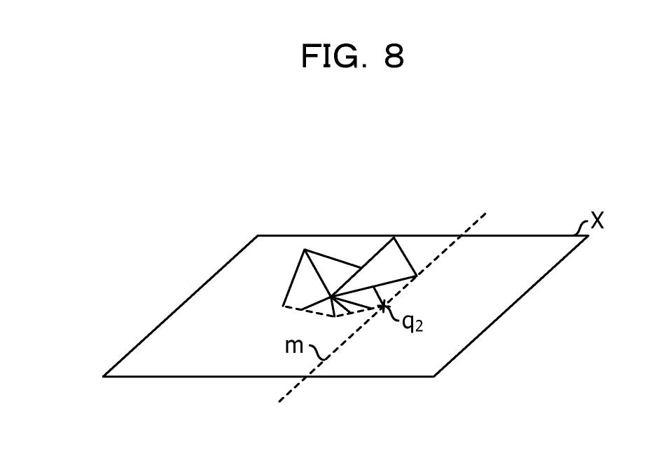

However, as schematically illustrated in FIG. 8, the line set in step S25 may not be the line “a” passing through the visual point “p”, but any one point “q₂” that has a maximum value or a minimum value in any one of an x-coordinate value, a y-coordinate value, and a z-coordinate value may be selected among the points of the polygons intersecting the cutting plane X, and a line “m” that passes the point “q₂” and the cutting plane X may be set.

Then, the polygon extraction unit 130 extracts a three-dimensional polygon contacting the line on the cutting plane, and the neighboring three-dimensional polygons, and stores the data of the three-dimensional polygons in the second data storage unit 140 (step S27). In the example in FIG. 7, three-dimensional polygons “r₁” and “r₂” that contact the line on the cutting plane, that is to say, that includes a contact point. However, depending on the density and the shape of the three-dimensional polygon group, even if a three-dimensional polygon positioned at the outer side of an object, the three-dimensional polygon does not contact the line, and thus the three-dimensional polygon sometimes fails to be extracted. Thus, in the present embodiment, the line is moved inward a little to the three-dimensional polygon group on the cutting plane, and a three-dimensional polygon that intersects the line after the move is also extracted as a neighboring three-dimensional polygon. This processing will be described in relation to step S31.

After that, the polygon extraction unit 130 rotates the line about the contact point on the cutting plane, and searches for a contact point at the minimum rotation angle (step S29). In this regard, if there are a plurality of contact points (or intersection points) because of roughness in resolution and in rotation angle, the farthest contact point from the previous contact point ought to be the next center of rotation.

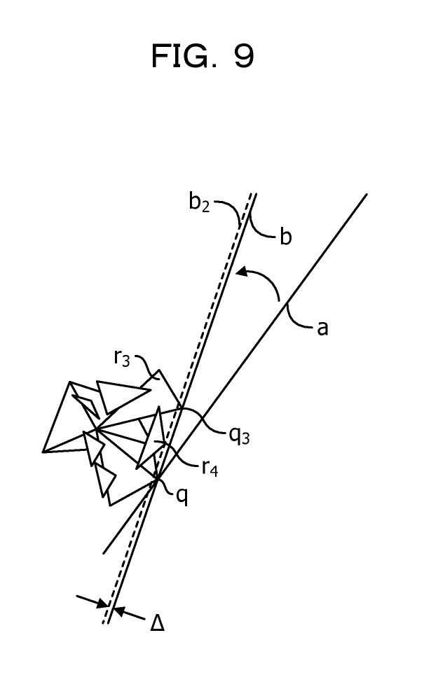

FIG. 9 illustrates a scene in which the line “a” is rotated with a contact point “q” as center on the same cutting plane as that in FIG. 7, and a line “b” that contacts the three-dimensional polygon group at a contact point “q₃” is obtained.

Then, the polygon extraction unit 130 extracts a three-dimensional polygon contacting the line on the cutting plane, and the neighboring three-dimensional polygons, and stores the data of those three-dimensional polygons into the second data storage unit 140 (step S31). In this regard, the data of the three-dimensional polygons that were already stored in the second data storage unit 140 are not redundantly stored.

In the example in FIG. 9, a polygon “r₃” contacting the line “b” is extracted. Further, a polygon “r₄” that intersects or contacts a line b₂, which is produced by moving the line “b” to the three-dimensional polygon group by Δ on the cutting plane X, is also extracted as a neighboring three-dimensional polygon.

After that, the polygon extraction unit 130 determines whether the line has made a round on the cutting plane or not (step S33).

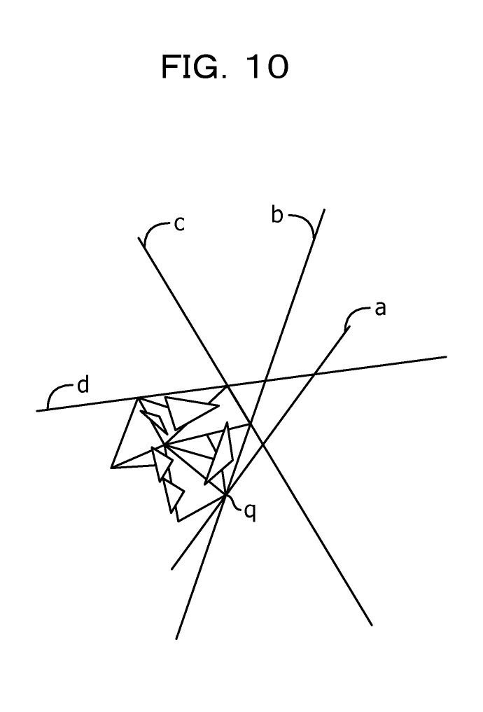

In the present embodiment, as schematically illustrated in FIG. 10, if a contact point between the line and the three-dimensional polygon group is found, the line is further rotated about the contact point. That is to say, the line is rotated until the coordinates return to the original contact point “q” or its vicinity. For example, the line “a” is rotated to obtain the line “b”, the line “b” is rotated to obtain a line “c”, and the line “c” is rotated to obtain a line “d”. In this regard, there are cases where the coordinates do not completely return to the original contact point “q”, and thus if a new three-dimensional polygon is not extracted, the processing is terminated.

If the line has not been rotated to make a round on the cutting plane, the processing returns to step S29. On the other hand, if the line has made a round on the cutting plane, the polygon extraction unit 130 determines whether the setting of a cutting plane covering the object to be visualized has been completed or not (step S35).

If the setting of a cutting plane covering the object to be visualized has not been completed, the polygon extraction unit 130 sets a different cutting plane (step S37), and the processing returns to step S23.

On the other hand, if the setting of a cutting plane covering the object to be visualized has been completed, the processing returns to the calling processing.

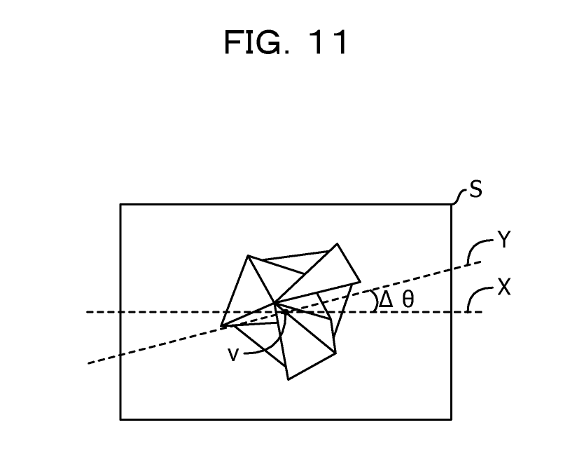

For example, as schematically illustrated in FIG. 11, if the cutting plane X is initially set as illustrated in FIG. 6, a rotation axis “v” passing through the cutting plane X, and passing through the object is set, and a cutting plane Y is set by rotating the cutting plane X about the rotation axis “v” by Δθ. In this manner, if the cutting plane is repeatedly rotated until the total Δθ becomes 360°, the cutting plane covering the whole object is set.

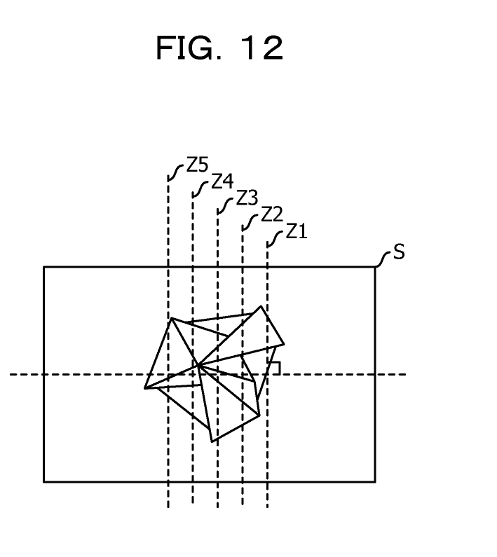

On the other hand, even if the cutting plane X is initially set as illustrated in FIG. 6, without rotating the cutting plane as illustrated in FIG. 12, cutting planes Z1 to Z5 that are perpendicular to the cutting plane X may be set at intervals of a predetermined width in order to sweep the object. Such cutting planes Z1 to Z5 may be set in accordance with a user's instruction. Also, a cutting plane Z that is perpendicular to the cutting plane X may be gradually moved, and after an intersecting three-dimensional polygon is detected, a predetermined width may be set, and then if no intersecting three-dimensional polygons are detected, the setting of a cutting plane may be stopped.

Returning to the description of the processing in FIG. 4, the drawing processing unit 150 executes drawing processing in accordance with the visual point set by the input unit 120 on the three-dimensional polygons stored in the second data storage unit 140, and outputs the result to the display unit 160 (step S5).

In the drawing processing, while hidden surface removal is performed using the data of the three-dimensional polygons stored in the second data storage unit 140, projection processing on a projection plane is performed. For example, a polygon disposed at the inner side with reference to the projection plane may be drawn in sequence, or a polygon disposed at the front side with reference to the projection plane may be drawn for each pixel using a Z buffer. Alternatively, the other methods may be used.

Then, if an instruction to change the visual point is given through the input unit 120 (step S7: Yes route), the drawing processing unit 150 sets the visual point in accordance with the instruction from the input unit 120 (step S9), and the processing returns to step S5. On the other hand, when an instruction to change the visual point is not given (step S7: No route), and if an instruction to terminate the processing is given through the input unit 120 (step S11: Yes route), the processing is terminated. Else if an instruction to terminate the processing is not given, (step S11: No route), the processing returns to step S7.

By performing such processing, the three-dimensional polygons to be subjected to the drawing processing are narrowed down out of the objects to be visualized, and thus the processing load of the image processing device 100 is reduced.

For example, it is assumed that there is a situation in which three-dimensional polygons are distributed on a sphere having a radius “r”=30, and one three-dimensional polygon is disposed in a volume 1 inside the sphere. At this time, the total number of polygons are obtained by calculating its volume, and the result is 4πr³/3=about 110 thousand three-dimensional polygons. On the other hand, the surface area is obtained by differentiating the volume, and since 4πr²=about 110 thousand polygons, if the processing like the present embodiment is performed, the number of three-dimensional polygons to be subjected to the drawing processing is reduced. Accordingly, the processing load is reduced.

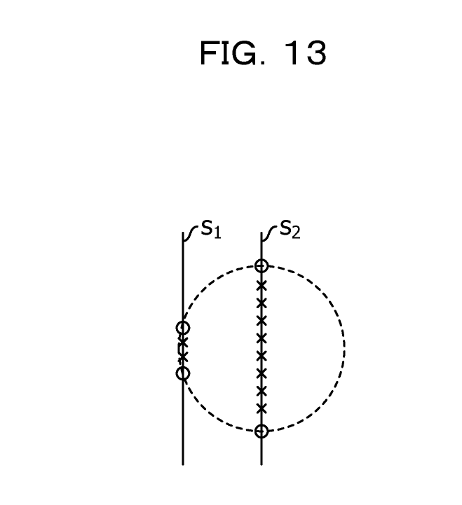

In this regard, it is thought that three-dimensional polygons located on the surface of an object are extracted by applying a scan line method. That is to say, a projection plane perpendicular to the visual line direction is set, and a perpendicular line is drawn from the projection plane toward the object, and the maximum and the minimum polygon coordinates having intersections are extracted. In FIG. 13, a dotted line denotes the surface of the sphere, and a scene for determining intersections between perpendicular lines s₁ and s₂, and the like, and the sphere is illustrated. Then, circular marks denote intersections with the sphere surface, and x marks denote intersections with the three-dimensional polygons inside the sphere. Thus, in the case of a cutting plane that passes through the center of the sphere, intersection determinations are performed for diameter 2r=60 times at the maximum, and one time at the minimum.

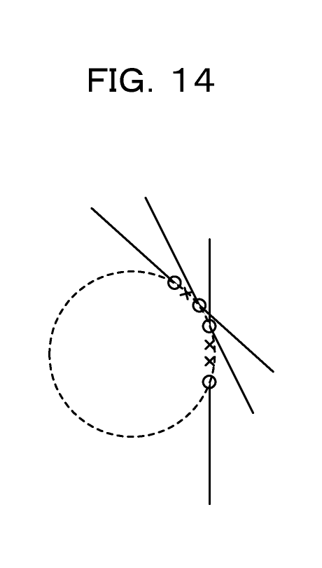

On the other hand, in the present embodiment, as schematically illustrated in FIG. 14, intersection calculation between the three-dimensional polygons and the line is performed by rotating the line. At this time, the line is rotated while the line is externally touching, and thus the number of the polygons that intersect is a few at the maximum. Accordingly, from such a viewpoint, the processing load is reduced.

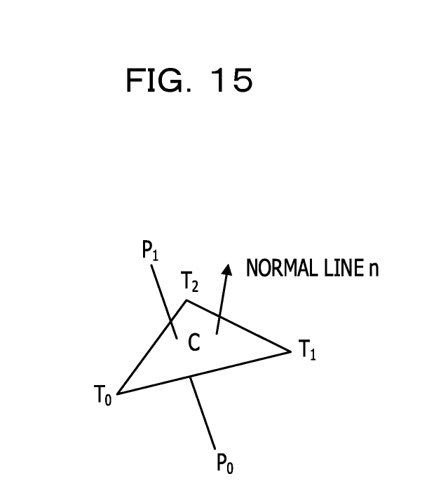

In this regard, the intersection determination between polygons and the line ought to be performed as follows. That is to say, it is assumed that the intersection determination between polygons and the line is carried out by the following procedure. As illustrated in FIG. 15, the intersection determination between a polygon (vertices T₁ to T₃) having a normal line “n” and a line segment P₀P₁ is considered.

(1) Determine a starting point P₀ and an end point P₁ of the line segment.

(2) Obtain the distance d₀ between the polygon and the point P₀, and the distance d₁ between the polygon and the point P₁.

(3) A point C obtained by internally dividing the vector P₀P₁ by the distance ratio d₀:d₁ becomes the intersection point.

(4) Calculate outer products of the vectors from the vertices of the polygon to the intersection point C, and the sides of the polygon (a total of three by three vertices and three sides), and if their directions match, the intersection point C is in the polygon. That is to say, a determination is made that the line segment intersects the polygon.

In the above, a description has been given of the embodiments of the present disclosure. However, the present disclosure is not limited to these.

For example, the configuration of the functional blocks illustrated in FIG. 3 is an example, and sometimes does not match the configuration of the program modules. For the processing flowcharts, as long as the processing result is not changed, the execution order of the steps may be exchanged, or a plurality of steps may be executed in parallel.

Further, a plurality of computers may share the above-described processing. Further, the image processing device 100 may be connected to another apparatus through a network, and may obtain data of an object from the other apparatus, and store the data into the first data storage unit 110.

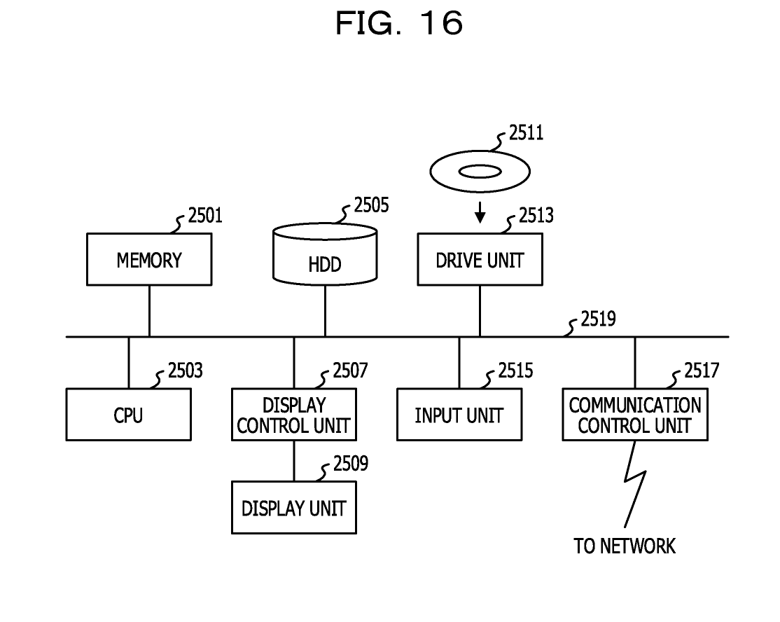

In this regard, the above-described image processing device 100 is a computer. As illustrated in FIG. 16, the computer has a configuration in which a memory 2501 as a main memory, a central processing unit (CPU) 2503 as an arithmetic processing unit, a hard disk drive (HDD) 2505 as an external storage device, a display control section 2507 connected to a display unit 2509, a drive unit 2513 for a removable disk 2511, an input device 2515, and a communication control unit 2517 for connecting to a network are connected through a bus 2519. An operating system (OS), and an application program for performing the processing according to the present embodiment are stored in the HDD 2505, and are read from the HDD 2505 into the memory 2501 when executed by the CPU 2503. The CPU 2503 controls the display control section 2507, the communication control unit 2517, and the drive unit 2513 in accordance with the processing contents of the application program, and causes them to perform predetermined operation. Also, the data in the middle of processing is mainly stored in

the memory 2501, but may be stored in the HDD 2505. In the embodiments of the present technique, the application program for performing the above-described processing is stored in the computer-readable removable disk 2511, and is distributed. Then, the application program is installed from the drive unit 2513 to the HDD 2505. The application program is sometimes installed into the HDD 2505 through a network, such as the Internet, or the like, and the communication control unit 2517. Such a computer achieves the above-described various functions by organically cooperating with the hardware, such as the CPU 2503, the memory 2501, and the like, and the programs, such as the OS, the application program, and the like.

The embodiments described above are summarized as follows.

The image processing device according to the present embodiment includes (A) a data storage unit for storing data on a set of three-dimensional polygons disposed in a three-dimensional virtual space, (B) an extraction unit for extracting a three-dimensional polygon that is externally disposed out of the set of three-dimensional polygons from the set of three-dimensional polygons stored in the data storage unit, and (C) a drawing processing unit for performing drawing processing on the three-dimensional polygons extracted by the extraction unit.

In the case of drawing an object including three-dimensional polygons inside in addition to the three-dimensional polygons for expressing an outer shape or a surface, the three-dimensional polygons to be subjected to the drawing processing are narrowed down by the above-described processing so that it becomes possible to reduce the processing load.

In this regard, in the case where the above-described set of three-dimensional polygons includes a three-dimensional polygon having a density equal to or higher than a predetermined density at the inner side rather than the outer side, it becomes more effective.

Also, for each of the plurality of planes cutting a set of three-dimensional polygons, the above-described extraction unit may rotate a line that externally touches a three-dimensional polygon group that intersect the planes so as to extract a three-dimensional polygon externally touching the line, and the neighboring three-dimensional polygons. By performing such processing, it becomes possible to extract three-dimensional polygons that represent an outer shape or a surface with less processing load.

Also, there are cases where the above-described plurality of planes are obtained by rotating an initial plane with a rotation axis passing through the inside of the set of three-dimensional polygons as center. It becomes easy to cover the whole set of three-dimensional polygons.

Further, the above-described plurality of planes may include a first plane, and a plurality of second planes that are perpendicular to the first plane. By such a method, it becomes possible to set a plane that covers the set of three-dimensional polygons.

Further, when the above-described extraction unit detects a contact point with a three-dimensional polygon group by rotating the line, the line may be further rotated with the contact point as center. It is possible to extract three-dimensional polygons with little processing load.

Further, the above-described extraction unit may set an initial contact point based on the minimum value or the maximum value among the coordinate values of the vertices of a three-dimensional polygon group, and may rotate the line passing through the initial contact point with the initial contact point as center. By such a method, it is possible to easily extract a three-dimensional polygon representing an outer shape or a surface.

In this regard, if a visual point is changed, the above-described drawing processing unit may perform the drawing processing (for example, including hidden surface removal, and the like) on the three-dimensional polygons extracted by the extraction unit. By this, the processing load is drastically reduced.

In this regard, it is possible to create a program that causes a processor to perform the above-described processing. The program is stored, for example in a flexible disk, an optical disc, such as a CD-ROM or the like, a magneto-optical disc, a semiconductor memory (for example, a ROM), a computer-readable storage medium, or a storage device, such as a hard disk, and the like. In this regard, the data in the middle of processing is temporarily saved in a storage device, such as a RAM, and the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An image processing device comprising:
a processor; and
a memory which stores a plurality of instructions, which when executed by the processor, cause the processor to execute:
extracting, with a data storage unit configured to store data on a set of three-dimensional polygons disposed in a three-dimensional virtual space, from the three-dimensional polygons stored in the data storage unit, the extracting a three-dimensional polygon disposed on an outer side of the set of three-dimensional polygons; and
drawing the extracted three-dimensional polygon.

2. The device according to claim 1,
wherein the set of three-dimensional polygons includes a plurality of three-dimensional polygons inside rather than outside the set of three-dimensional polygons.

3. The device according to claim 1,
wherein the set of three-dimensional polygons includes three-dimensional polygons at a density equal to or higher than a predetermined density rather than outside the set of three-dimensional polygons.

4. The device according to claim 1,
wherein for each of a plurality of planes cutting the set of three-dimensional polygons, the extracting includes rotating a line externally contacting a three-dimensional polygon group so as to extract a three-dimensional polygon circumscribing the line, and a three-dimensional polygon in a vicinity of the three-dimensional polygon.

5. The device according to claim 4,
wherein the extraction unit is configured to obtain the plurality of planes by rotating an initial plane with a rotation axis passing through inside the set of three-dimensional polygons as center.

6. The device according to claim 4,
wherein the plurality of planes include a first plane, and a plurality of second planes perpendicular to the first plane.

7. The device according to claim 4,
wherein when detecting a contact point with the group of three-dimensional polygons by rotating the line, the extracting includes further rotating the line with the contact point as center.

8. The device according to claim 7,
wherein the extraction unit is configured to set an initial contact point based on a minimum value or a maximum value among coordinates of vertices of the group of three-dimensional polygons, and rotate a line passing through the initial contact point as the initial contact point as center.

9. The device according to claim 7,
wherein even if a visual point is changed, performing drawing processing on the three-dimensional polygons extracted by the extraction unit.

10. A method of processing an image, the method comprising:
extracting, with a data storage unit configured to store data on a set of three-dimensional polygons disposed in a three-dimensional virtual space, from the three-dimensional polygons stored in the data storage unit, the extracting a three-dimensional polygon disposed on an outer side of the set of three-dimensional polygons; and
drawing, by a computer processor, the extracted three-dimensional polygon.

11. The method according to claim 10,
wherein the set of three-dimensional polygons includes a plurality of three-dimensional polygons inside rather than outside the set of three-dimensional polygons.

12. The method according to claim 10,
wherein the set of three-dimensional polygons includes three-dimensional polygons at a density equal to or higher than a predetermined density rather than outside the set of three-dimensional polygons.

13. The method according to claim 10,
wherein for each of a plurality of planes cutting the set of three-dimensional polygons, the extracting includes rotating a line externally contacting a three-dimensional polygon group so as to extract a three-dimensional polygon circumscribing the line, and a three-dimensional polygon in a vicinity of the three-dimensional polygon.

14. The method according to claim 13,
wherein the extraction unit is configured to obtain the plurality of planes by rotating an initial plane with a rotation axis passing through inside the set of three-dimensional polygons as center.

15. The method according to claim 13,
wherein the plurality of planes include a first plane, and a plurality of second planes perpendicular to the first plane.

16. The method according to claim 13,
wherein when detecting a contact point with the group of three-dimensional polygons by rotating the line, the extracting includes further rotating the line with the contact point as center.

17. The method according to claim 16,
wherein the extraction unit is configured to set an initial contact point based on a minimum value or a maximum value among coordinates of vertices of the group of three-dimensional polygons, and rotate a line passing through the initial contact point as the initial contact point as center.

18. The method according to claim 16,
wherein even if a visual point is changed, performing drawing processing on the three-dimensional polygons extracted by the extraction unit.

19. A non-transitory computer-readable medium that stores an image processing program for causing a computer to execute a process comprising:
extracting, with a data storage unit configured to store data on a set of three-dimensional polygons disposed in a three-dimensional virtual space, from the three-dimensional polygons stored in the data storage unit, the extracting a three-dimensional polygon disposed on an outer side of the set of three-dimensional polygons; and
drawing the extracted three-dimensional polygon.
